(19) United States
(12) Patent Application Publication
(10) Pub. No.: US 2003/0154347 A1
(43) Pub. Date: Aug. 14, 2003

(54) Methods and apparatus for reducing processor power consumption

(76) Inventors: Wei Ma, Castro Valley, CA (US); Jie Liang, Fremont, CA (US); Kah Yong Lee, Union City, CA (US); Kiak Wei Khoo, Union City, CA (US)

Correspondence Address: John S. Beulick, Armstrong Teasdale LLP, One Metropolitan Sq., Suite 2600, St. Louis, MO, 63102, US

(21) Appl. No.: 10/192,599

(22) Filed: Jul. 10, 2002

Related U.S. Application Data
(60) Provisional application No. 60/356,303, filed on Feb. 12, 2002.

(51) Int. Cl. G06F 12/00

(52) U.S. Cl. 711/131; 711/154

(57) ABSTRACT

A method for reducing power consumption within a processing architecture, the processing architecture including a processor and a memory device, the memory device having a memory cell, the processor having a processing element, the processor configured to read from the memory device and write to the memory device is described. The method comprises configuring the memory with logical processing circuits internal to the memory device which access the memory cell, performing logical operations to data within the memory cell utilizing the logical processing circuits within the memory device, and performing mathematical operations within the processing element of the processor. The method is embodied through a logic memory which significantly reduces power consumption of digital signal processors, microprocessors, micro-controllers or other computation engines in electronic systems. Logic memory is applicable to low power devices and system_on_a_chip (SoC) chips and is utilized in computer architecture design to improve speed and power efficiency.

### CROSS-REFERENCE TO RELATED APPLICATIONS

This application claims the benefit of U.S. Provisional Application No. 60/356,303, filed Feb. 12, 2002.

### BACKGROUND OF THE INVENTION

This invention relates generally to semiconductor chip design, and more specifically to reduction of power consumption in processing circuits.

In integrated circuit design, power consumption is becoming a critical issue. Digital Signal Processors (DSPs) are often the major power consumption source in SoC (system on a chip) integrated circuits. In DSPs, or for that matter, other processors, for example, microprocessors, microcontrollers, and network processors, one of the largest causes of power consumption is the movement of data between memory and processing elements (PE) or processing cores. Reducing the data movement is one of the most effective methods for reducing power consumption. Many methods have been developed, for example, reduced instruction set (RISC) processors, and cache memory, which move the data from a large memory to registers and local (cache) memory near the processing elements. However, power consumption continues to be a problem, even where these methods are implemented.

A DSP is a special microprocessor which focuses on numerical computations, such as multiplication operations and addition operations. However, bit manipulations and logical operations are increasing in many systems and algorithms. Examples of bit manipulation includes, but is not limited to, interleaving, bit stream formatting, and word segmentation. Bit manipulations are normally very simple operations, but may consume a large amount of power as data is moved back and forth between memory and processing elements. For example, in MPEG audio coding, bit manipulations may constitute as much as 30-50% of the processing performed.

### BRIEF DESCRIPTION OF THE INVENTION

In one aspect, a method for reducing power consumption within a processing architecture, the processing architecture including a processor and a memory device, the memory device having a memory cell, the processor having a processing element, the processor configured to read from the memory device and write to the memory device is provided. The method comprises configuring the memory with logical processing circuits internal to the memory device which access the memory cell, performing logical operations to data within the memory cell utilizing the logical processing circuits within the memory device, and performing mathematical operations within the processing element of the processor.

In another aspect, a memory device is provided which comprises a memory cell, a word address decoder configured to enable word access of the memory cell, a logical operations control (LOC) port, a logic operations unit (LOU), and a bit address decoder configured to enable bit access of the memory cell. The LOC port is configured to enable control of logic operations within the memory cell and bit positioning operations within the memory cell.

In still another aspect, a processing architecture is provided which comprises a program memory, a data memory, and a processing element. The processing element comprises at least one of a mathematical operations unit, a program sequencer for execution of program instructions within the program memory, a decoder for determining instruction type, and a data address generator for addressing the data memory. The data memory is configured to perform at least a portion of logical operations contained within the program instructions.

In a further aspect a digital signal processor architecture is described. The architecture comprises a DSP core comprising a configurable math unit, an arithmetic logic unit and a multiplier/accumulator. The architecture also comprises a program memory, a logic memory comprising a logic operation unit, an instruction decoder, and a program sequencer configured to extract program instructions and data from the program memory and pass the program instructions and data to the instruction decoder. The instruction decoder is configured to pass program instructions and data not supported by the logic memory to the DSP core, and to pass program instructions and data supported by the logic memory for processing by the logic memory.

### BRIEF DESCRIPTION OF THE DRAWINGS

FIG. 1 illustrates a general architecture of processors.

FIG. 2 illustrates a DSP architecture which uses logic memory.

FIG. 3 is a block diagram of a logic memory.

FIG. 4 is a block diagram of a logic memory where two memory locations have been reserved for LOC control purposes.

FIG. 5 is a block diagram illustrating an example of bit group extract operation using a logical memory.

FIG. 6 is a block diagram of one embodiment of a quasi-dual port smartRAM.

FIG. 7 is a block diagram of one embodiment of a quasi-tri port smartRAM.

FIG. 8 illustrates an architecture for a ultra low power DSP incorporating logic memory.

### DETAILED DESCRIPTION OF THE INVENTION

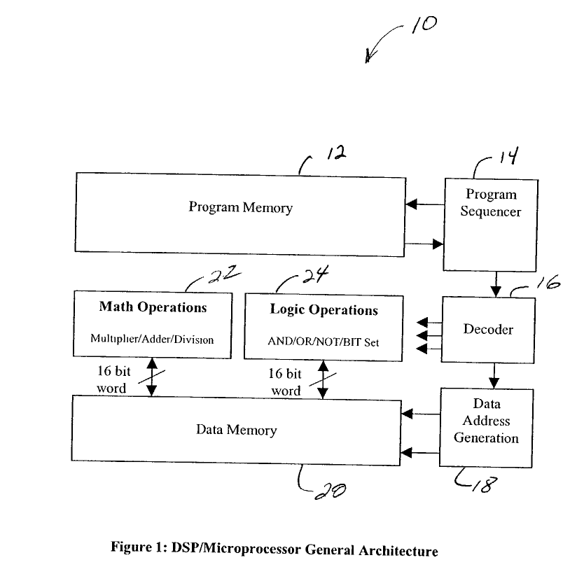

FIG. 1 illustrates a general architecture 10 of known Digital Signal Processors (DSP) and microprocessors. An executable program stored in a program memory 12 is executed utilizing a program sequencer 14. A decoder 16 receives instructions within the program through program sequencer 14 and determines what type of operation is to be performed, for example, mathematical or logical. Decoder 16 further determines whether a data address is to be generated utilizing data address generator 18, thereby allowing access to data memory 20. Based on the instructions within program memory 12 as decoded by decoder 16, data from data memory 20 is written to or read back from a math operation unit 22 or a logic operations unit 24.

In architecture 10, at least two types of processing operations are performed, namely, mathematical operations and logical operations. Mathematical operations are typically performed by a math operations unit 22 and logical operations are performed by a logic operations unit 24. In known DSPs, math operations unit 22 is the most heavily used processing element. Math operations unit 22 performs, for example, multiplication, additions and division. Such numerical operations typically require large amounts of circuitry to implement. Typically, input and output word patterns in these numerical operations are word based. Each data word represents a math variable or a constant. The word length can be 8 bit, 16 bit, 32 bit or even longer depending on accuracy desired in the computation. In order to implement the mathematical operations efficiently, data memories 20 have been designed to fit the word length. In most known systems, a typical word length is 16 bit fixed points or 32 bit floating points.

However, logical operations performed by logic operation unit 24 are normally bit by bit processing operations. A memory, for example, data memory 20, configured for word access often provides a difficult or at least an inefficient solution when supporting logical operations. One known practice is to read the word from memory 20, extract the desired bit from the word, and process the bit. Table 1 illustrates a common logical operation processing flow, including a typical number of processor clock cycles for each operation.

TABLE 1
Operation Sequence Example

| | |
|---|---|
| 1. move memory DATA 1 to REGISTER1 | 1 cycle |
| 2. extract BIT1 from REGISTER1 | 2 cycles |
| 3. logic operation to BIT1 | 1 cycle |
| 4. assemble word REGISTER1 | 2 cycles |
| 5. move REGISTER1 to memory DATA2 | 1 cycle |

The operation as illustrated in Table 1 uses seven processor clock cycles to complete the sequence. However, the logic operation to BIT 1, which only needs one clock cycle, is the operation which provides the desired result, programwise. The other operations serve only to move the data from memory to registers within the processor and back to memory again. Examples of such operations include, but are not limited to, bit set, bit reset, AND, OR, XOR, bit packing, bit unpacking, bit interleaving and bit error detection and correction. Most processor clock cycles are used in the movement of data to and from data memory and logic operations unit 24 which is a very high processing overhead. The reason behind the overhead is memory word formatting and data formatting implemented to process the data in a central processing unit where math and logic operations are performed. The central processing unit (CPU) concept comes from older concepts of sharing silicon resources and a computer arithmetic model. However, since silicon has become a very low cost item, distributed processing methods can be made available, which distributes the processing logic to places where processing is needed in order to reduce data movement.

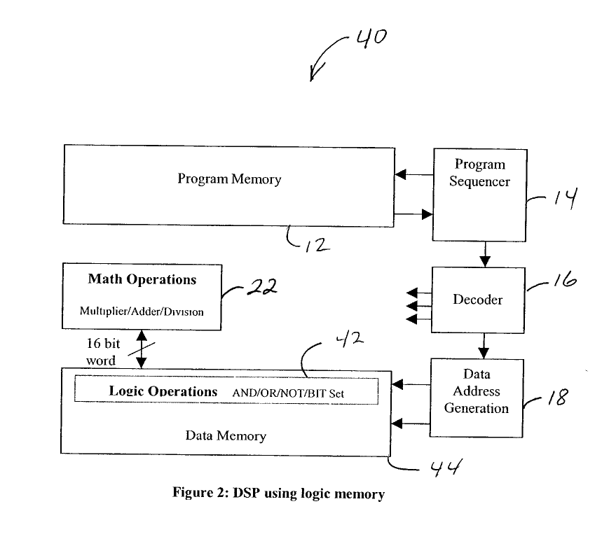

FIG. 2 illustrates a DSP architecture 40 which implements a logic operations unit 42 within a portion of data memory 44. Logical operations have moderate circuitry requirements as compared to mathematical operations. Therefore, in the embodiment shown, logical operations are performed within logic operations unit 42 of data memory 44. Performing at least a portion of the logical operations within a program inside logic operations unit 42, allows a reduction in a number of processing cycles needed to complete the logical operations as compared to known processing methods. The reduction in processing cycles is attributable to not having to move data to and from a processor in order to perform certain logical operations. Further, as bit access is available within most memories, logic operations are easily implemented. By moving logical operations into data memory 44, power consumption is reduced as compared to known data movement and bit assembly operations. A memory which includes a logic operations unit 42, is referred to herein as a logic memory.

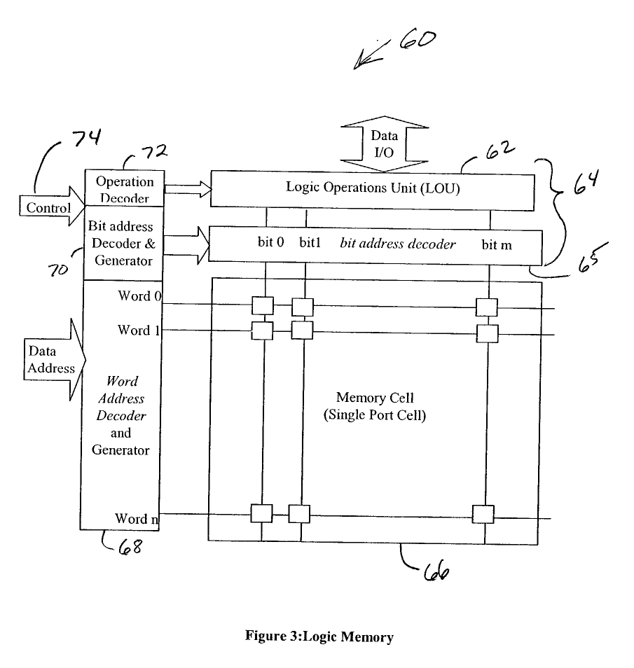

FIG. 3 illustrates a logic memory 60. A logic operation unit (LOU) 62 includes processing circuits which are located in a data input/output portion 64 of memory 60. Data input/output portion 64 also includes a bit address decoder 65. Memory 60 further includes a memory cell 66, similar to that in known memories, and control circuitry. The control circuitry includes a word address decoder and generator 68, a bit address decoder and generator 70, and an operation decoder 72.

Logical operations supported in LOU 62 of logic memory 60 are relatively simple operations, therefore the logical operations do not cause memory read and write overhead (i.e. processor cycles) to increase, since there is no movement of data to and from memory 60. These logical operations are typically related to, although not limited to, bit operations, which as described above, are inefficient when implemented in processing elements of microprocessor cores. The logical operations listed in Table 2 are a non-exhaustive list of operations which may be implemented within LOU 62 of logic memory 60. Depending on algorithms, the operations may be partly or fully implemented:

TABLE 2
Possible logic operations

Bit setting and resetting
Bit invert
Bit test or extract
Word clear and pattern setting
Leading bit detection
Word boundary shift
Word scaling
Word shift operations
Bit group extract (stream unpacking)
Bit group assembly (stream packing)
Bit steam interleave and deinterleave
Bit AND, OR and XOR operations
Word AND, OR and XOR operations
Address Generation
Error Detection and Correction
Multiple word assembly and disassembly

Implementing logic memory 60 reduces DSP or microprocessor power consumption in at least the following three aspects. First, the bit and logic operation computation clock cycle counts are reduced, as logical operations work directly on a storage bit within memory 60. For example, the operation sequence illustrated in Table 1 is reduced to a one cycle execution when logic memory 60 is utilized. Second, data movement between program memory and processing elements are reduced. For example, data copying is done in logic memory 60 without drive output ports and buses. In one embodiment, logic memory 60 is utilized to generate an amount of addressing, so as to reduce flow in providing addresses to memory from processing elements. Third, memory reading and writing is done in a partial word format, thereby providing a reduction of power as compared to the power typically used to drive a whole memory word as in known architectures.

An interface to access a logic memory is the same as known memory accessing, apart from an additional port, herein called a logic operations command (LOC) port 74. LOC port 74 includes bit address decoder and generator 70 and operation decoder 72 and is used to control the logic operations and bit positioning within logic memory 60. For example, a logic operation command of set(bit7), means set the 7^{th} bit to 1. A word location (data address) is still passed through word address decoder and generator 68. In one embodiment, a LOC is 16 bits wide. In alternative embodiments, an LOC is other widths depending on memory structure. For a tri-port RAM, the LOC may be 32 bits. For a simple single port RAM, the LOC may be 8 bits.

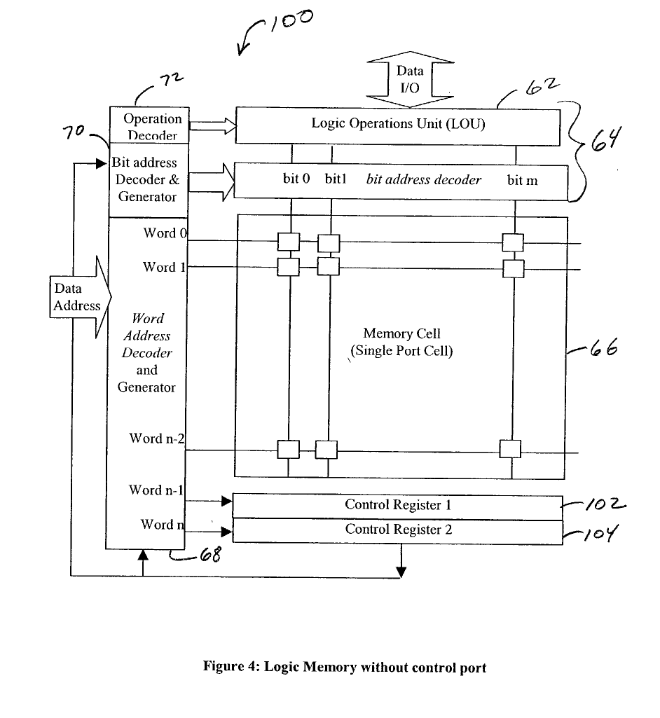

Interfaces to logic memory 60, in one embodiment, are implemented in the same manner as is done in known memory architectures, in order to facilitate integration to existing DSPs or other processors which do not support LOC port 74. In one embodiment, logic memory 60 utilizes a few memory locations which are configured to act as an indirect LOC port. FIG. 4 illustrates a logic memory 100 where two memory locations 102 and 104 have been reserved for LOC control purposes. Before activating logic memory functions, a user writes a control word to memory locations 102 and 104, thereby configuring the indirect LOC port of logic memory 100. For example, users can access logic memory 100 in a three bit format word by setting up an addressing format, so that each address bus increment results in a three bit increment in memory.

Single port RAM is the most frequently used RAM in DSP and microprocessor applications. Logic memory 100, in a random access memory (RAM) embodiment, is used as a smart RAM (smRAM) to reduce data movement and increase processor efficiency. However, known single port RAM can only read or write once in one cycle. Therefore, implementation of logical operations which need two or more operands in one cycle is difficult. Even though, logic memory which is implemented with single port RAM still provides a benefit to many DSP and microprocessor applications as a number of logical operations do not use two operands.

Most logical operations are within one of four classes. A first class is single operand operations and includes bit setting and resetting, bit inversions, bit test or extractions, word clear, word pattern setting, leading bit detection, word boundary shift (read word without word boundary), and address generation. Since the above listed operations only utilize one operand, one address is enough to implement the desired logical operation. Since bit operations utilize more detailed addresses, to specify which bit, the provided address has additional bits, in addition to the bits in a typical word address. For example, to identify specific bits in a 16-bit word, four additional bits are used. In one embodiment, the address generation is not a stand-alone function, but can automatically increment, and decrement and counter, to reduce address data flow and power consumption further.

A second class of logical operations includes single operation includes single operand reading and writing operations, including, but not limited to, word scaling and word shift operations. In such operations, data is read from a memory cell and written back later to the same cell. The read and write operations use different clock edges, sometimes referred to as two-pump memory, therefore such a logical operation is accomplished within one instruction cycle.

A third class of operations includes single operand reading and writing operations which may access two memory addresses. Such two address logical operations include word shifting operations, bit group extraction operations (stream unpacking), bit group assembly operations (stream packing), and bit stream interleaving and de-interleaving operations. Such operations may only need one operand, but the operation writes a result of the operation back to another memory location. There are three output situations to consider in the third class of logical operations. First, an output to a processor core, such as, data load instructions. Second, an output to another memory location within the same memory block. Third, an output to another memory location within a different memory block.

A fourth class of logic operations utilizes two operands, which means two addresses are provided. Known single port memory architectures do not accept two addresses at the same time, so two instructions are implemented to perform the logic operation. Examples of two operand operations include, but is not limited to, bit AND, OR and XOR operations, word AND, OR and XOR operations, and other two operand operations. Utilization of a logic memory to perform two operand logic operations reduces power consumption of a processor based architecture by not moving the operand data out of memory, even though two instructions are used in performing the logic operation. To make two operand operations in a logic memory more efficient, a dual-port or a tri-port logic memory is utilized.

By employing the logic memory methods described herein, all four classes of logical operations can be implemented with a resultant reduction in processor power consumption. However, micro-architectures of the logic memory may be implemented differently. For example, the second class needs two addresses, which single port memory cannot support within one instruction cycle. One solution is to use two instructions operated with the previously mentioned two-pump memory, so the logical operation can still be implemented in one clock cycle. An alternative embodiment utilizes relative addressing, wherein a destination address is automatically generated within memory by adding a relative distance from a current memory location.

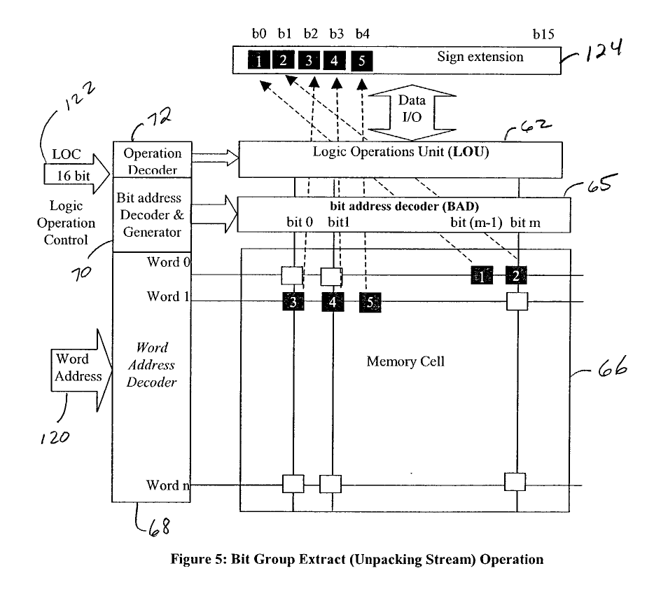

FIG. 5 illustrates an example of a bit group extraction operation from logical memory 60 (also shown in FIG. 3). In the illustration, a number of consecutive bits are being extracted from memory cell 66 which is configured with word boundaries. At the beginning of the extraction operation, a received word address 120 causes word address decoder 68 to point to word zero. A logic operation command 122, which is received by operation decoder 72 and bit address decoder and generator 70 includes a bit group extract command and a length of the bit group to be extracted. In the illustrated example, the bit group length is five. Based upon logic operation command 122, bit address decoder 65 points to bit address (m−1), which is the first bit to be extracted of the group of five bits. In the illustrated example, since the first bit of the group is bit (m−1), the remaining four of the bit group to be extracted includes bit m in word 0 and bits 0, 1, and 2 in word one. All bits within the group of five bits are enabled.

Bit positioning is accomplished by logic operation unit 62, by filling at least a portion of an I/O word 124. In the example shown, the I/O word is filled with the five bits, bits one through five, including a sign extension (or all zero depending on operations). I/O word 124, including the grouping of the five bits, is output to a processing core or written back to one or more address locations. In an alternative embodiment (not shown), bit addressing is not needed as there is a counter incorporated in logic operations unit (LOU) 62 to accumulate the group length for every read. The above described bit manipulating operations are important in stream audio processing applications such as MPEG and AC3. Some known DSPs take at least 20 processing cycles to perform these bit manipulation operations, which reduces available processing time by an order of 20-30 MIPS.

### Quasi Dual Port Smart RAM (QD-smRAM)

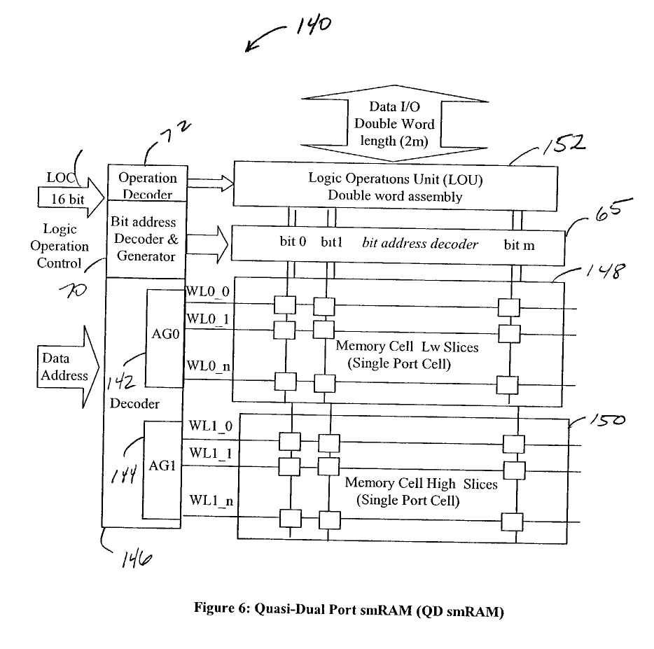

In one embodiment of a logic memory 140, illustrated in FIG. 6, multiple data loading capability is provided through utilization of multiple port RAM, specifically, a quasi dual port smart RAM (QD-smRAM). Examples of multiple port RAM include, dual port RAM and tri-port RAM, which brings about an increase in memory cell area. For example, a dual port RAM utilizes eight transistors while a single port RAM utilizes only six transistors. Many processing cores implement a multiple data loading capability, as the data may come from different locations. Logic memory 140 provides a solution as two simple address generators 142 and 144 are implemented to automatically generate multiple addresses within word address decoder 146 to multiple memory slice banks 148 and 150, respectively. In FIG. 6, memory slice bank 148 is configured as low memory slices and memory slice bank 150 is configured as high memory slices. Individual bits are accessed utilizing bit address decoder 65, bit address decoder and generator 70, and operation decoder 72 as described above. After memory slice banks 148 and 150 are accessed, then the multiple output word is assembled into a long word using LOU 152, which supports double word length assembly.

One example of utilization of a logic memory which incorporates QD-smRAM is a finite impulse response (FIR) filter. In an FIR filter, two data words are used to load data to the processing core from memory. One data word is a coefficient and the other is data. If a bit width is 16 bits, output word length is 32 bits. In such an implementation, address generators 142 and 144 are configured to point to an odd memory slice bank and an even bank and automatically increment at every cycle. Such a utilization results in an implementation of a simple logic assembly circuit to be incorporated into LOU 152, which combines two 16-bit words into one 32-bit word and output. The QD-smRAM example described above is implemented using a very small silicon area, has a low power consumption, and is very flexible for both double word read operations and dual address read operations.

### Quasi Tri-Port Smart RAM (QT-smRAM)

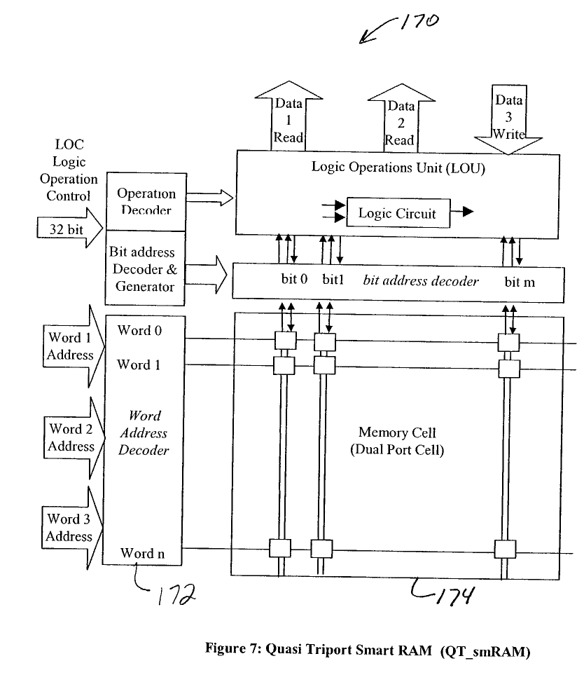

An embodiment of a quasi tri-port smart RAM (QT-smRAM) logic memory 170 is shown in FIG. 7. QT-smRAM logic memory 170 incorporates all of the functionality of single port smRAM logic memory 60 (shown in FIG. 3), as described above, but also includes functionality to support two and three operand operations. QT-smRAM logic memory 170 includes a word address decoder 172 capable of addressing three addresses to select three memory words or cells within memory cell 174, which allows support of two-operand logic operations, for example, AND, OR and XOR. Memory cell 174 of QT-smRAM is a single port cell, which saves area in fabrication of logic memory 170, as compared to the above described dual-port memory (QD-smRAM), which implements two write operations. In one embodiment, QT_smRAM logic memory 170 supports one write operation and two read operations. In such an embodiment, it is contemplated that any known logic operation can be accomplished in QT-smRAM logic memory 170.

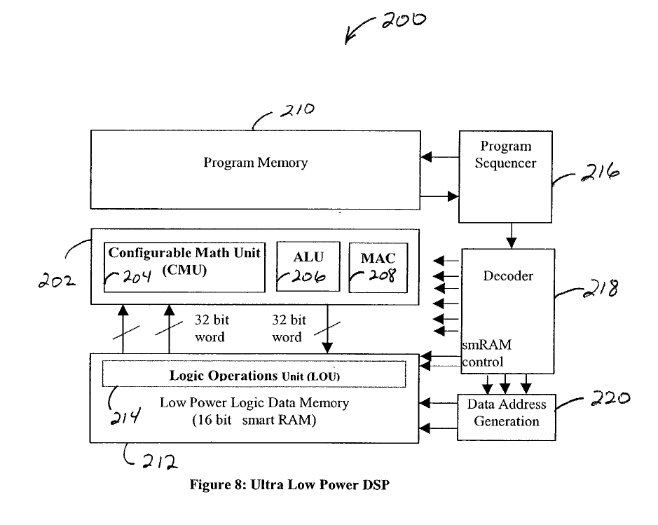

FIG. 8 illustrates one embodiment of a DSP architecture 200 which provides an ultra low power DSP and utilizes a logic memory as smartRAM. Referring specifically to architecture 200, a DSP processing core 202 includes a configurable math unit (CMU) 204, an arithmetic logic unit (ALU) 206, and a multiplier/accumulator (MAC) 208. Architecture 200 includes both a program memory 210 and a logic memory 212, which further includes a logic operations unit (LOU) 214. A program sequencer 216 extracts program instructions and data from program memory 210 and passes the instructions and data onto an instruction decoder 218. Decoder 218, is configurable to pass program instructions and data not supported by logic memory 212 to DSP 202 for processing. In addition, decoder 218 is further configurable to recognize instructions, and the corresponding data, which will be processed within logic memory 212. Upon such a recognition, decoder 218 provides codes to data address generator 220 to provide the decoding into the memory cell (not shown) of logic memory 212. Upon completion of the logic operation, logic operation unit (LOU) 214 passes the resultant data to DSP 202.

In order to reduce power consumption, DSP architecture 200 uses low power smartRAM on top of other power saving mechanisms, such as low voltage and low power processing elements (i.e. sequencer 216 and decoder 218). In order to effectively use smartRAM within logic memory 212, a number of logic memory instructions are included in the processing elements to control the smartRAM. Such a configuration is well suited to known configurable DSPs where instructions can be easily added.

If DSP 202 is to perform full parallel processing, very long instructions are needed. To implement very long instructions within a low power DSP architecture, for example, architecture 200, one or more of the following are implemented. A smartRAM logic memory is utilized with a DSP core which has a configurable math unit (CMU), to better support the CMU. A new group of instructions is created which controls logic operations and address generations, for example, those listed in Table 2. A DSP decoder is utilized to decode micro-code routines. The micro-code routines support parallel operations of both smartRAM and other DSP processing elements. In one embodiment, the micro code routines are running within one instruction cycle. Examples of such micro code routines include combinations of Memory logic, MAC, ALU, CMU, and data address generation (DAG) operations, combination of memory operation with any one of operations from a MAC, an ALU or a CMU, and complex memory operations plus DAG operations.

In certain embodiments, although a smartRAM can perform some basic logic operations, a DSP core is also able to perform some logic operations utilizing a full-function ALU and CMU to meet requirements of more complicated instructions. Overall, adding a smartRAM allows additional operations to be performed in parallel with DSP, so that the same functions can be completed utilizing a lower clock rate. This allows designers to use lower supply voltages, thereby reducing power consumption.

The above described embodiments outline utilization of logic memory to reduce power consumption in DSP and other processing architectures. Power consumption is reduced by moving a number of simple logic operations to memory blocks (i.e. logic memory) to reduce a need for moving data to processing elements for logical operations. Bit related operations are also more easily performed in memory blocks as compared to execution within word-based processing cores, thereby reducing cycle counts of processor operations.

As further described above, one exemplary embodiment of logic memory includes a logic operations control interface, a logic operations unit (LOU) and address decoders and generators. In the embodiment, the LOU and bit select circuitry is added to an I/O port of the memory, and an address generation unit is added to an address decoder unit of the memory. Such a logic memory is able to perform logic operations such as, but not limited to, bit setting and resetting, bit stream packing and unpacking, bit and word shuffling, and internal movement of data, without increasing processing overhead, due to data movement, as is currently the case in known processing architectures. Interfaces to the logic memory are similar to those in known memory architectures apart from an additional control port, the logic operations control (LOC) interface. Input codes received at the LOC interface are decoded into logic operations and bit selections.

Configuring a memory cell of a logic memory as a single port smart RAM allows support of most single operand logic operation while allowing a small die area. A quasi dual port smart RAM includes address generation allowing access to two data operands using a single port memory cell. The quasi dual port smart RAM utilizes dual banks for access to each of a single port memory cell and a combined I/O port. In the I/O port, two words from different banks can be assembled into one long word through the LOC unit, solving the problem in known memories that only adjacent words can be assembled into long words. The operation is accomplished through addition of an address generator into the address decoder section. A quasi tri-port smart RAM supports all two operand logic operations and moves a result out of the memory in one operation.

In another embodiment a logic memory is constructed without an LOC interface. In this embodiment, a number of cells within the memory are used to store and generate control signals, and therefore is capable of integration with existing DSP and processor cores. By utilization of logic memory with existing DSP and processor cores existing application software is leveraged, as new instructions are not added, rather, control codes are used for loading of memory locations. In such an embodiment, programmers are able to modify the control code in software to optimize the logic memory implementation and save power.

Utilization of logic memory is maximized if instructions are added to a processor core, the instructions added according to types of logic memory and applications supported. More efficiently, DSP and other processors are able to function with logic memory in a fully parallel mode by using Parallel Micro Code (PMC), which allows for control of both the logic memory and the processing core at the same time. Although described herein with respect to a DSP, it is to be understood that the methods and embodiments described herein are also applicable to microprocessors, microcontrollers, RISC processors, ASICs, network processors, system on a chip processors, and any other type of processing unit.

While the invention has been described in terms of various specific embodiments, those skilled in the art will recognize that the invention can be practiced with modification within the spirit and scope of the claims.

What is claimed is:

1. A method for reducing power consumption within a processing architecture, the processing architecture including a processor and a memory device, the memory device having a memory cell, the processor having a processing element, the processor configured to read from the memory device and write to the memory device, said method comprising:
configuring the memory with logical processing circuits internal to the memory device which access the memory cell;
performing logical operations to data within the memory cell utilizing the logical processing circuits within the memory device; and
performing mathematical operations within the processing element of the processor.

2. A method according to claim 1 wherein the memory includes an I/O port and an address decoder unit, said configuring the memory with logical processing circuits comprises:
adding a logic operations unit and a bit select circuit to the I/O port of the memory device; and
adding an address generation unit to an address decoder unit of the memory device.

3. A method according to claim 1 wherein the memory includes a logical operations control (LOC) port, said performing logical operations comprises decoding input codes at the LOC port into logic operations and bit selection.

4. A method according to claim 1 wherein the memory is a single port smart RAM, said performing logical operations comprises supporting single operand logic operations.

5. A method according to claim 1 wherein said configuring the memory with logical processing circuits comprises utilizing a portion of the memory to store and generate control signals.

6. A method according to claim 1 wherein the memory is a quasi dual port smart RAM, said performing logical operations comprises supporting dual operand logic operations.

7. A method according to claim 6 wherein the memory includes two address generators and a logic operations unit, said supporting dual operand logic operations comprises:
generating addresses to multiple memory slice banks using the address generators; and
assembling a resulting multiple output word into a long word using the logic operations unit.

8. A method according to claim 1 wherein the memory is a quasi tri-port smart RAM, said performing logical operations comprises:
supporting dual operand logic operations; and
sending a result of the operations out of the memory.

9. A memory device comprising:
a memory cell;
a word address decoder configured to enable word access of said memory cell;
a logical operations command (LOC) port; and
a logic operations unit (LOU).

10. A memory device according to claim 9 wherein said LOC port comprises:
a bit address decoder configured to enable bit access of said memory cell; and
an operations decoder configured to enable control of logic operations in said memory cell and bit positioning within said memory cell.

11. A memory device according to claim 9 wherein said LOU comprises processing circuits in an I/O port of said memory device.

12. A memory device according to claim 9 wherein said LOC port is implemented indirectly utilizing a portion of said memory cell for LOC control purposes.

13. A memory device according to claim 9 wherein said memory device comprises a single port smart RAM, said memory device configured to support single operand logic operations.

14. A memory device according to claim 9 wherein said memory device comprises a quasi dual-port smart RAM, said memory cell comprising a plurality of memory slice banks, said memory device configured to support one and two operand logic operations.

15. A memory device according to claim 14 wherein said word address decoder comprises two address generators to generate addresses to said plurality of memory slice banks, said memory device configured to assemble a resulting multiple output word into a long word using said logic operations unit.

16. A memory device according to claim 9 wherein said memory device comprises a quasi tri-port smart RAM, said memory device configured to support one, two, and three operand logic operations.

17. A processing architecture, comprising:
a program memory;
a data memory; and
a processing element comprising at least one of a mathematical operations unit, a program sequencer for execution of program instructions within said program memory, a decoder for determining instruction type, and a data address generator for addressing said data memory, said data memory configured to perform at least a portion of logical operations contained within the program instructions.

18. A processing architecture according to claim 17 wherein said data memory comprises:
a memory cell;
a word address decoder configured to enable word access to said memory cell;
a logical operations control (LOC) port;
a logic operations unit (LOU); and
a bit address decoder configured to enable bit access of said memory cell, said LOC port configured to enable control of logic operations in said memory cell and bit positioning within said memory cell, said LOU configured to perform logic operations as controlled by said LOC port.

19. A processing architecture according to claim 18 wherein said LOU comprises processing circuits in an I/O port of said data memory.

20. A processing architecture according to claim 18 wherein said LOC port is implemented indirectly utilizing a portion of said memory cell for LOC control purposes.

21. A processing architecture according to claim 18 wherein said memory cell comprises a single port smart RAM, said data memory configured to support single operand logic operations.

22. A processing architecture according to claim 18 wherein said memory cell comprises a quasi dual-port smart RAM, said memory cell comprising a plurality of memory slice banks, said data memory configured to support one and two operand logic operations.

23. A processing architecture according to claim 22 wherein said word address decoder comprises two address generators to generate addresses to said plurality of memory slice banks, said logic operations unit configured to assemble a resulting multiple output word into a long word.

24. A processing architecture according to claim 18 wherein said memory cell comprises a quasi tri-port smart RAM, said data memory configured to support one, two, and three operand logic operations.

25. A processing architecture according to claim 17 wherein said processing element comprises a DSP, a microprocessor, a microcontroller, a RISC processor, an ASIC, a network processor, and a system on a chip processor.

26. A digital signal processor architecture comprising
a DSP core comprising a configurable math unit, an arithmetic logic unit and a multiplier/accumulator;
a program memory;
a logic memory comprising a logic operation unit;
an instruction decoder; and
a program sequencer configured to extract program instructions and data from said program memory and pass the program instructions and data to said instruction decoder, said instruction decoder configured to pass program instructions and data not supported by said logic memory to said DSP core, and to pass program instructions and data supported by said logic memory for processing by said logic memory.

27. A digital signal processor architecture according to claim 26 comprising a data address generator, said instruction decoder configured to pass program instructions and data supported by said logic memory to said data address generator.

28. A digital signal processor architecture according to claim 27 whereupon completion of the program instructions supported by logic memory, said logic operation unit passes resultant data to said DSP core.

29. A digital signal processor architecture according to claim 26 wherein said program memory and said logic memory comprise smartRAM.

30. A digital signal processor architecture according to claim 26 wherein said decoder is utilized to decode micro-code routines.
